(19) United States
(12) Patent Application Publication
(10) Pub. No.: US 2026/0269854 A1
(43) Pub. Date: Sep. 10, 2026

(54) Antenna Array Power Amplifier Mismatch Mitigation

(71) Applicant: Telefonaktiebolaget LM Ericsson (publ), Stockholm (SE)

(72) Inventors: Christian Elgaard, Lund (SE); Henrik Sjöland, Lund (SE); Imad ud Din, Flyinge (SE); Hans Hagberg, Limhamn (SE)

(21) Appl. No.: 18/871,743

(22) PCT Filed: Jun. 16, 2022
(86) PCT No.: PCT/EP2022/066515

§ 371 Date: Dec. 4, 2024

(51) Int. Cl. H04B 1/04

(52) U.S. Cl. CPC H04B 1/0483; H04B 1/0475; H04B 2001/0416

(57) ABSTRACT

In a wireless communication transmitter including a plurality of power amplifiers (PA) having individually varying load conditions, and transmitting the same digital signal, the output voltages Vₒᵤₜ of the PAs are monitored. A median value PA voltage V_{median} is determined. The gain of a programmable gain amplifier preceding each PA is adjusted to drive the output voltage Vₒᵤₜ of that PA towards the median value V_{median}. By making the output voltage swings of all PAs less divergent, distortion is minimized, and is more consistent between PAs, making it more amenable to removal by Digital PreDistortion (DPD) techniques. Reliability is also improved, as no one PA experiences significantly higher voltage swings, which could reduce its lifetime. The PA output voltages may diverge due to changing load impedances, which occur, for example, with changes in transmission angle of a beamforming array.

### TECHNICAL FIELD

The present disclosure relates generally to wireless communication, and in particular to a system and method of mitigating power amplifier mismatch in transmitter antenna arrays.

### BACKGROUND

Wireless communication networks, including network nodes and radio network devices such as cellphones and smartphones, are ubiquitous in many parts of the world. These networks continue to grow in capacity and sophistication. To accommodate both more users and a wider range of types of devices that may benefit from wireless communications, the technical standards governing the operation of wireless communication networks continue to evolve. The fourth generation of network standards (4G, also known as Long Term Evolution, or LTE) has been deployed, the fifth generation (5G, also known as New Radio, or NR) is in development or the early stages of deployment, and the sixth generation (6G) is being planned. One important development in modern wireless communication networks is the use of beamforming (also known as beamsteering), wherein the directionality of a Radio Frequency (RF) transmission is increased and controlled to “aim” in a specific direction. Antenna Array Systems (AAS) have been developed to facilitate beamforming. The AAS may comprise a large array of antenna elements, each connected (directly or through an antenna switch) to a transceiver. For the transmitter, beamforming is accomplished by independently shifting the phases of signals transmitted by different antenna elements. The phase shifts are calculated such that at a certain angle from the AAS, the phase-shifted RF signals constructively interfere, and a “lobe” is generated, having a much higher gain than signals transmitted at any other angle. By controlling the phases of signals transmitted by each antenna element, the lobe can be “steered,” or directed to predetermined angles.

The phase shifting to implement beamforming can be done in the digital domain, before the Digital to Analog Converter (DAC) in each transmitter. The phase shifting can also be implemented in the analog domain, between the DAC and the Power Amplifier (PA). Hybrid beamforming refers to implementing some phase shift in the digital domain, and some in the analog domain. There are many considerations for which beamforming method to use, but one very strong reason to use analog or hybrid beamforming is that the power consumption of the digital part can be shared between many transmitter antenna element branches, increasing the overall transmitter efficiency.

Radio frequency PAs are inherently nonlinear, especially when they are operating with high efficiency. Therefore, PAs typically must be linearized to meet linearity requirements in wireless communication systems. The PAs' non-linearity may otherwise ruin the quality of the transmitted signal, i.e., provide too high an Error Vector Magnitude (EVM), and/or disturb communication in neighboring frequency channels, commonly measured by Adjacent Channel Leakage Ratio (ACLR). Typically, linearization of the PA is performed using Digital PreDistortion (DPD), which can compensate for amplitude to amplitude variation (AM-AM), amplitude to phase variation (AM-PM), and memory effects.

A DPD can operate in open loop mode, where the DPD has a predetermined fixed distortion, or in closed loop mode, where the DPD measures the quality of the PA output signal and adapts the predistortion to maximize it. PAs in AAS targeted to operate in, e.g., a 5G system should preferably be linearized using individual DPDs, since each PA has its own input signal, which is true for the digital beamforming case. This requires the use of power-hungry, dedicated DPD hardware for each PA. However, because the adaptation can have limited speed, the feedback path of a closed loop DPD can potentially be used as a shared resource between multiple transmitters, in a round robin manner.

For analog or hybrid beamforming, the digital input signal is shared between multiple PAs, and hence the DPD linearization will be identical for all PAs, as long as the PAs are identical and their environment, especially the load impedance, is the same. The closed loop DPD feedback signal for such a case can be either a summation or a subset of the output signals. For some cases—where different PAs are of identical design and operate under similar conditions—this works satisfactorily. However, if the PAs behave differently due to operating under different conditions, for instance having different load impedance, the benefit of the DPD will be reduced.

As a beamforming antenna array steers a transmit beam, i.e., adjusting the phase difference between antenna element signals to change the transmit direction, the different PAS in the antenna array experience large changes in load impedance. This means that the beam steering angle will modulate the load impedance that each PA sees. Even worse for the DPD, the load impedance also depends on the position of the antenna element in the antenna array, so that different PAs will see different load impedances.

FIGS. 1A and 1B show the simulated radiated power of 22 different antenna elements in a row of an AAS. Because the PA models driving the antennas for this case are ideal, the radiated power is a good measure of the impedance matching. FIG. 1A shows the radiated power vs. frequency for a beamforming steering angle of zero degrees. FIG. 1B shows the radiated power vs. frequency for a beamforming steering angle of 60 degrees. These plots show that as the beam angle increases, the variation is larger-both with respect to frequency and also between different antenna elements.

Even worse, when the antenna array is deployed in a handheld device, the user grip additionally impacts effective antenna impedance. Accordingly, PAs in a handheld device with the same input signal will experience different load impedances as a function of steering angle, frequency, and user grip, all of which reduce the benefit of DPD.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to aspects of the present disclosure described and claimed herein, in a transmitter including a plurality of power amplifiers (PA) having individually varying load conditions, and transmitting the same digital signal, the output voltages Vₒᵤₜ of the PAs are monitored. A median value PA voltage V_{median} is determined. The gain of a programmable gain amplifier preceding each PA is adjusted to drive the output voltage Vₒᵤₜ of that PA towards the median value V_{median}. By making the output voltage swings of all PAs less divergent, distortion is minimized, and is more consistent between PAs, making it more amenable to removal by Digital PreDistortion (DPD) techniques. Reliability is also improved, as no one PA experiences significantly higher voltage swings, which could reduce its lifetime. The PA output voltages may diverge due to changing load impedances, which occur with changes in transmission angle of a beamforming array.

One aspect relates to a transmitter for a wireless communication device. The transmitter includes a Digital to Analog Converter (DAC) configured to convert a digital communication signal to an analog communication signal. The transmitter further includes a plurality of transmitter paths. Each transmitter path is configured to receive the analog communication signal and output a transmission signal. Each transmitter path includes: a programmable gain amplifier configured to receive the analog communication signal and output an amplified analog communication signal; a Power Amplifier (PA) configured to receive the amplified analog communication signal and output the transmission signal; and a voltage detector connected to the output of the PA and configured to measure a voltage amplitude of the transmission signal. The transmitter further includes a controller connected to each voltage detector and each programmable gain amplifier. The controller is configured to adjust a gain of each programmable gain amplifier so as to reduce variation in the voltage amplitudes of the plurality of transmission signals.

Another aspect relates to a method of equalizing Power Amplifier (PA) outputs in a transmitter including a Digital to Analog Converter (DAC) and a plurality of transmitter paths. Each transmitter path is configured to receive the same analog signal from the DAC, and comprising a serial connection of a programmable gain amplifier, a PA, and a voltage detector. For each transmitter path, a gain G_{PA} for the programmable gain amplifier is set equal to a nominal gain Gₙₒₘ, and a voltage amplitude Vₒᵤₜ is measured at the output of the PA. A median PA output voltage amplitude V_{median} is calculated. For each transmitter path, the following loop is repeated until either Vₒᵤₜ=V_{median} within a predetermined tolerance, or no further adjustment of the gain is possible: (1) compare the measured voltage amplitude, Vₒᵤₜ, to the median PA output voltage amplitude, V_{median}; (2) if Vₒᵤₜ<V_{median}, increase the gain, if possible; (3) if Vₒᵤₜ>V_{median}, decrease the gain, if possible; and (4) measure a new voltage amplitude Vₒᵤₜ at the output of the PA.

Yet another aspect relates to a User Equipment (UE) operative in a wireless communication network. The UE includes one or more transmitters. Each transmitter includes a Digital to Analog Converter (DAC) configured to convert a digital communication signal to an analog communication signal. The transmitter further includes a plurality of transmitter paths. Each transmitter path is configured to receive the analog communication signal and output a transmission signal. Each transmitter path includes: a programmable gain amplifier configured to receive the analog communication signal and output an amplified analog communication signal; a Power Amplifier (PA) configured to receive the amplified analog communication signal and output the transmission signal; and a voltage detector connected to the output of the PA and configured to measure a voltage amplitude of the transmission signal. The transmitter further includes a controller connected to each voltage detector and each programmable gain amplifier. The controller is configured to adjust a gain of each programmable gain amplifier so as to reduce variation in the voltage amplitudes of the plurality of transmission signals.

Still another aspect relates to a base station operative in a wireless communication network. The base station includes one or more transmitters. Each transmitter includes a Digital to Analog Converter (DAC) configured to convert a digital communication signal to an analog communication signal. The transmitter further includes a plurality of transmitter paths. Each transmitter path is configured to receive the analog communication signal and output a transmission signal. Each transmitter path includes: a programmable gain amplifier configured to receive the analog communication signal and output an amplified analog communication signal; a Power Amplifier (PA) configured to receive the amplified analog communication signal and output the transmission signal; and a voltage detector connected to the output of the PA and configured to measure a voltage amplitude of the transmission signal. The transmitter further includes a controller connected to each voltage detector and each programmable gain amplifier. The controller is configured to adjust a gain of each programmable gain amplifier so as to reduce variation in the voltage amplitudes of the plurality of transmission signals.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the invention to those skilled in the art. Like numbers refer to similar elements throughout.

FIG. 1A is a graph showing PA output voltages as a function of frequency, and between amplifiers in a beamforming antenna array with a beamsteering angle of 0°.

FIG. 1B is a graph showing the same PA output voltages with a beamsteering angle of 60°.

FIG. 2 is a block diagram of a transmitter.

FIG. 3 is a flow diagram of a method of equalizing PA outputs in a transmitter.

FIG. 4A is a graph of Tx reference, non-linearized, and linearized output signal frequency spectrums of a PA driving a 25Ω load, amplifying a signal pre-distorted by a DPD model targeted to a 50Ω load, using a nominal gain.

FIG. 4B is a graph of Tx reference, non-linearized, and linearized output signal frequency spectrums of a PA driving a 25Ω load, amplifying a signal pre-distorted by a DPD model targeted to a 50Ω load, using an increased gain based on the PA output.

FIG. 5A is a graph of Tx reference, non-linearized, and linearized output signal frequency spectrums of a PA driving a 100Ω load, amplifying a signal pre-distorted by a DPD model targeted to a 50Ω load, using a nominal gain.

FIG. 5B is a graph of Tx reference, non-linearized, and linearized output signal frequency spectrums of a PA driving a 100Ω load, amplifying a signal pre-distorted by a DPD model targeted to a 50Ω load, using a decreased gain based on the PA output.

FIG. 6A is a diagram of transmission on the air interface of a wireless communication network.

FIG. 6B is a hardware block diagram of the UE of FIG. 6A.

FIG. 6C is a hardware block diagram of the base station of FIG. 6A.

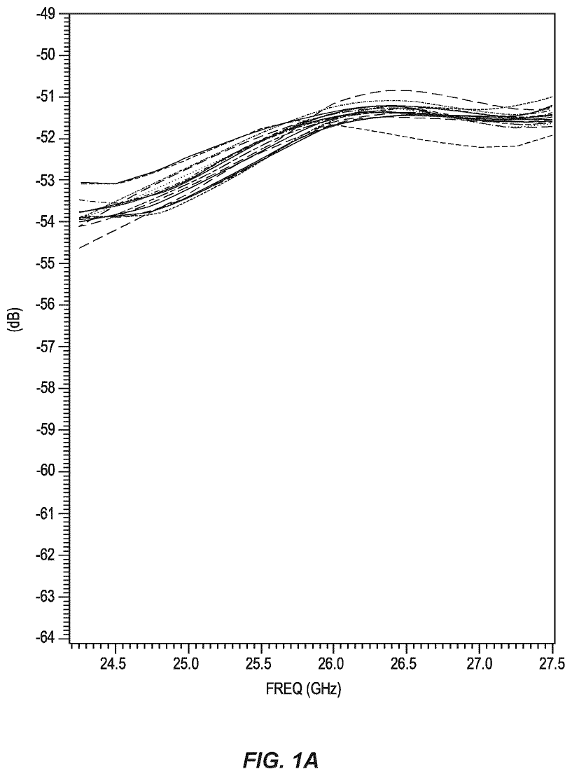

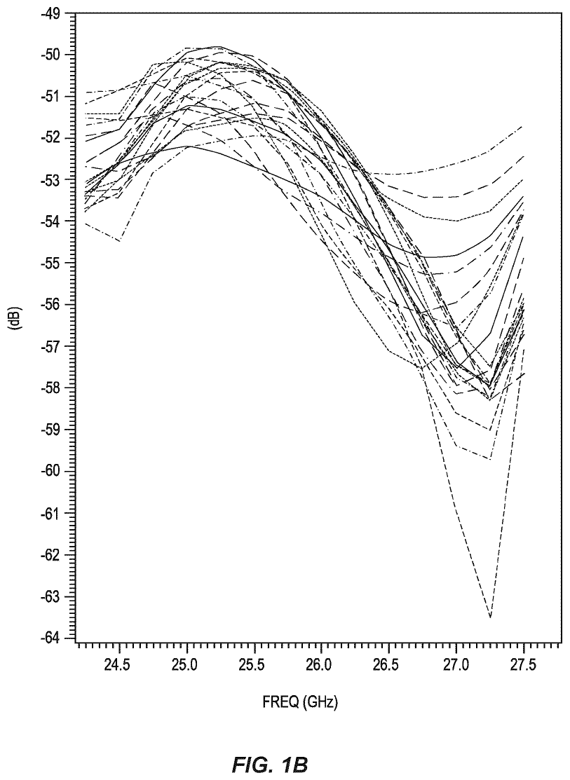

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

As known in the art, there are many sources of distortion introduced by the power amplifier (PA) in a transmitter. Such distortion is largely dependent on the amplitude of the PA output voltage swing, which in turn is dependent on the output load. This implies that for changing load conditions, the output voltage swing will vary, and so will the distortion. As discussed above, a major source of changing load impedance seen by PAs in an Antenna Array System (AAS) is beamforming. The load impedance seen by a PA is dependent on the beamsteering angle of the array, the signal frequency, the position of the associated antenna element in the array, and for handheld devices, the user grip. Regardless of the source of differing load impedances, however, equalizing the output amplitude of PAs in a transmitter mitigates the distortion.

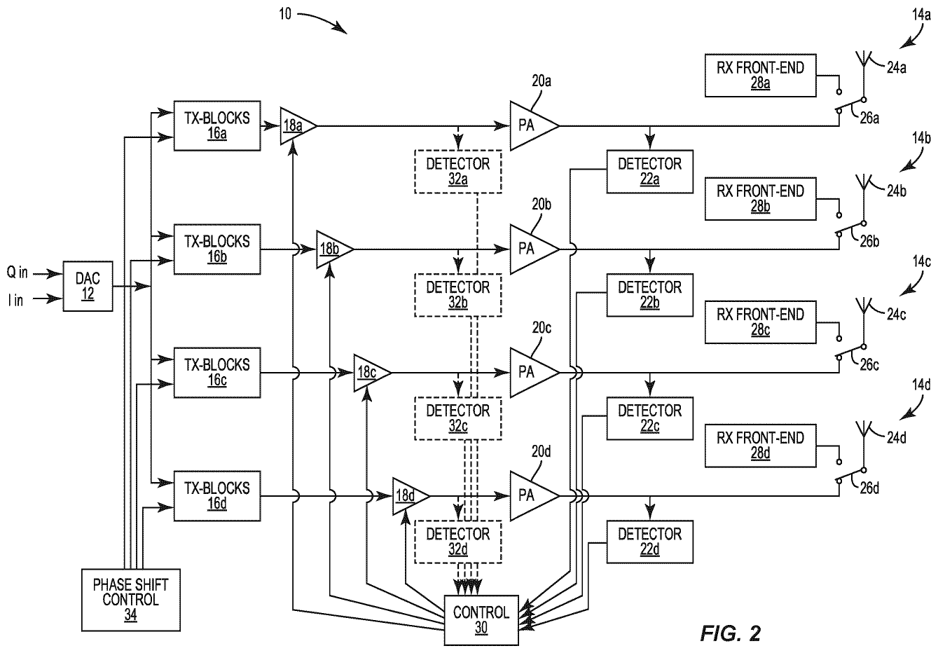

FIG. 2 is a block diagram of a transmitter 10 for a wireless communication device, according to one aspect of the present disclosure. The transmitter 10 depicted in FIG. 2 may be a complete transmitter. Alternatively, it may represent a portion of a (possibly much) larger transmitter, such as for an AAS. The transmitter 10 includes a Digital to Analog Converter (DAC) 12 receiving a baseband digital communication signal. In the aspect depicted, the digital communication signal comprises In-phase (I) and Quadrature (Q) components. In some aspects, the digital communication signal has been processed by a Digital PreDistortion (DPD) process (not shown). The DAC 12 is configured to convert the digital communication signal to an analog communication signal.

The same analog communication signal is distributed to a plurality of transmitter paths 14a-d, each of which includes a PA 20a-d. Different beamforming phase shifts may be applied to each transmitter path 14a-d, as directed by a phase shift control unit 34. FIG. 2 depicts four transmitter paths 14a, 14b, 14c, 14d for convenience (referred to collectively herein as transmitter paths 14), but this is not limiting. In various aspects, a transmitter 10, or sub-array of an AAS, may comprise any number of transmitter paths 14 receiving a common communication signal. Each transmitter path 14 is configured to receive the analog communication signal, apply a beamforming phase shift, and output a transmission signal, which feeds an antenna element 24, either directly or through an antenna switch 26.

Each transmitter path 14 includes an analog Tx processing block 16, which may include various circuits and implement various functions, as known in the art. For example, the Tx processing block 16 may implement phase shifting for analog beamforming, pre-amplification, analog filtering, frequency up-conversion, and the like. According to aspects of the present disclosure, each transmitter path 14 additionally includes a programmable gain amplifier 18 upstream of the PA 20. The programmable gain amplifier 18 may follow the Tx processing block 16, as depicted in FIG. 2. Alternatively, it may precede, or be part of, the Tx processing block 16. The programmable gain amplifier 18 is configured to receive the analog communication signal from the DAC 12 (optionally processed by various Tx processing circuits or functions), and output an amplified analog communication signal. As discussed further herein, each programmable gain amplifier 18 applies an individual gain to the analog communication signal, as determined by a gain controller 30.

Each transmitter path 14 further includes a PA 20 configured to receive the amplified analog communication signal (either directly from the programmable gain amplifier 18, as depicted in FIG. 2, or after some Tx processing if the programmable gain amplifier 18 is located further upstream), and output the transmission signal, which is fed to an antenna element 24, either directly or via an antenna switch 26 which may alternately connect the antenna 24 to receiver (Rx) front end circuitry 28. According to aspects of the present disclosure, each transmitter path 14 further includes a voltage detector 22 connected to the output of the PA 20. The voltage detector 22 is configured to measure a voltage amplitude of the transmission signal (i.e., the output voltage of the PA, referred to herein as Vₒᵤₜ). An output of each voltage detector 22 is connected to the gain controller 30.

The gain controller 30 receives a voltage amplitude of each PA output from the associated voltage detector 22. The gain controller 30 analyzes the PA output voltage amplitudes, and generates an individual gain control signal for the programmable gain amplifier 18 in each transmitter path 14, so as to reduce variation in the voltage amplitudes of the plurality of transmission signals, as further discussed herein. Note that in some aspects, the gain controller 30 and the phase shift controller 34 may be combined.

For signal levels below voltage clipping, a simple model of a CMOS PA 20 is a voltage controlled current source with voltage to current conversion G. For this model, the output power can be expressed as:

$${P}_{out} = {v}_{out} \cdot {i}_{out} , where$$

$${v}_{out} = {v}_{i n} \cdot G \cdot R and {i}_{out} = {v}_{i n} \cdot G , hence$$

$${p}_{out} = {v}_{i n} \cdot G \cdot R \cdot {v}_{i n} \cdot G = {v}_{i n}^{2} \cdot {G}^{2} \cdot R , where$$

pₒᵤₜ is the output power [W];
vᵢₙ is the input voltage [V];
Vₒᵤₜ is the output voltage [V];
iₒᵤₜ is the output current [A];
G is the transconductance of the PA; and
R is the resistance of the load [Q].

Even when a high Peak to Average Ratio (PAR) OFDM modulated input signal drives the PA 20 into voltage compression, the output power can still be increased by increasing the input signal, since for the majority of the time the input signal will still be below voltage clipping. Gradually, as the input signal voltage is increased, the output power will increase less, since a larger portion of the signal causes voltage clipping. Also, the distortion will increase, since a larger portion of the signal is not linearly amplified. For PAs 20 with identical input signals, a higher output power can be expected for PAs 20 that drive a higher load impedance, and they will also have a more distorted output signal. For these PAs 20, reducing the input signal voltage will lower the PA output amplitude-ideally keeping it in the range of other PAs 20 in the transmitter.

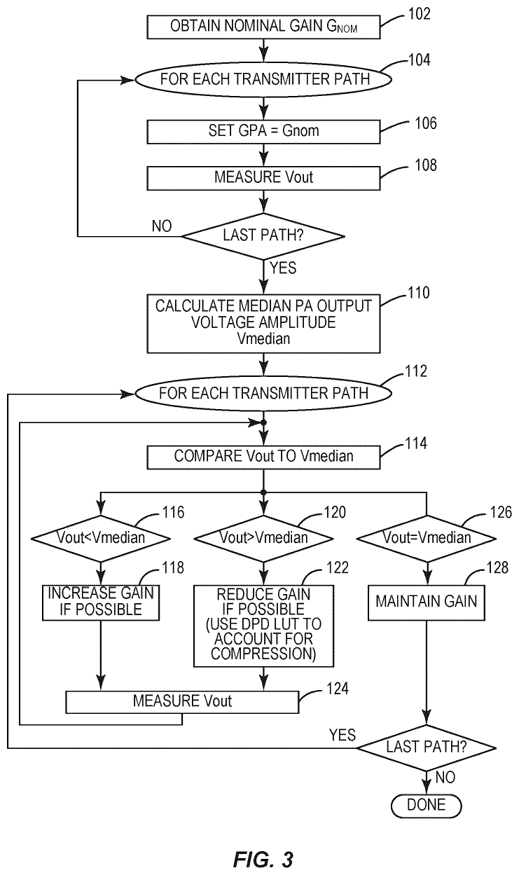

FIG. 3 depicts the steps in a method 100, performed by the gain controller 30 of FIG. 2, of equalizing PA outputs. A nominal gain Gₙₒₘ for the programmable gain amplifiers 18 is obtained (block 102), such as from a control processor, configured in memory, or the like. Initially, for each transmitter path 14 (loop 104), the gain G_{PGA} of the programmable gain amplifier 18 is set equal to the nominal gain Gₙₒₘ (block 106), and the resulting voltage amplitude Vₒᵤₜ at the output of the PA 20 is measured (block 108). A median PA output voltage amplitude V_{median} is calculated from the measured Vₒᵤₜ values (block 110). The following loop is then executed for each transmitter path (loop 112):

repeat
compare the measured voltage amplitude Vₒᵤₜ to the median PA output voltage amplitude V_{median} (block 114)
if Vₒᵤₜ<V_{median} (block 116), increase the gain, if possible (block 118);
if Vₒᵤₜ>V_{median} (block 120) decrease the gain, if possible (block 122); and
measure a new voltage amplitude Vₒᵤₜ at the output of the PA 20 (block 124);
until either Vₒᵤₜ=V_{median} within a predetermined tolerance, or no further adjustment of the gain is possible.

Note that, during the gain adjustment loop, if Vₒᵤₜ=V_{median} within a predetermined tolerance (block 126), no gain adjustment is made, and the current gain is maintained (block 128). At this point, the voltage amplitudes Vₒᵤₜ at the PA outputs in each transmitter path 14 are as close to each other as possible, at or near the median PA output voltage amplitude V_{median} for the nominal gain Gₙₒₘ.

In one aspect, an optimization when the PA output voltage Vₒᵤₜ is high can reduce the number of iterations. When the output voltage Vₒᵤₜ is high, the PA may have entered voltage compression. In that case, when reducing the input signal by x dB, the output will reduce by less than x dB. If compression is not taken into account, several iterations of gain reduction may then be required to achieve the desired level of Vₒᵤₜ=V_{median}. If, however, this effect is considered, the output may reach V_{median}. in one, or very few, iterations, thus speeding up the operation. Information regarding compression can be obtained from the DPD coefficients, which may be stored in a Look Up Table (LUT). The information is not perfect, as the output impedance is deviating, but it can help. Alternatively, compression information can be accumulated from the iteration adjustments—in this case, fewer iterations may be required when the system has built up some information regarding the output voltage compression.

In one aspect, the method 100 of equalizing PA 20 outputs is repeated following each significant beamsteering shift to a different angle (for example, any beamsteering angle change in excess of a predetermined threshold). In another aspect, the values of Vₒᵤₜ are periodically measured, and the method of equalizing PA 20 outputs is repeated when the voltage amplitudes Vₒᵤₜ of a predetermined number of PAs 20 have deviated a predetermined amount from the Vₒᵤₜ values set during the last iteration of the method 100 (i.e., correcting for drift).

To prevent excessive wear or damage to the PAs 20 and other components, in some aspects the gain of each programmable gain amplifier 18 is adjusted so as to limit the voltage amplitudes of the transmission signals to not exceed a predetermined threshold. Similarly, in some aspects the gain of each programmable gain amplifier 18 is adjusted so as to limit the output current of the transmission signal to not exceed a predetermined threshold. In these aspects, the current threshold for each transmission signal may be estimated from the gain applied to the corresponding programmable gain amplifier 18. In some aspects (as indicated by dashed lines in FIG. 2), a second voltage detector 32 is connected to the input of each PA 20, with its output connected to the controller 30. The controller 30 then estimates a current threshold for each transmission signal from a voltage amplitude of the amplified analog communication signal at the PA 20 input. These voltage and current thresholds relate to how close to clipping, or how near the limits of the safe operating area (SOA), the PA transistors are allowed to operate, in terms of voltage and/or current. Determining the voltage and current thresholds is a tradeoff between output power, reliability, and linearity.

Aspects of the present disclosure were verified by simulating a Doherty PA design at 27 GHz in a 22 nm Fully Depleted Silicon On Insulator (FD-SOI) process, using a 1600 MHz modulated OFDM signal with a PAR of 7 dB. The simulation was performed for each case of a nominal 50-ohm load impedance, a 25-ohm impedance, and a 100-ohm impedance. The latter values represent two points on the real axis of a Voltage Standing Wave Ratio (VSWR) circle of 2:1 around the 50-ohm point. The simulations were carried out in the time domain and with very large input signals, so that three models of the PA, containing nonlinearities and memory effects, could be built. Separate models were built for the case of 50-ohm load impedance, 25-ohm impedance, and 100-ohm impedance. A DPD was implemented as a Look Up Table (LUT) with five memory taps, and with a Tx baseband (BB) filter with a 3 dB bandwidth of 1200 MHz. The DPD was adapted to optimize performance in the 50-ohm model. Much of the DPD linearization bandwidth needed to linearize ACLR1 is filtered out by the TX BB filter, resulting in very marginal improvement for ACLR. This means the focus of the simulations was on in-band linearization performance, i.e., Error Vector Magnitude (EVM).

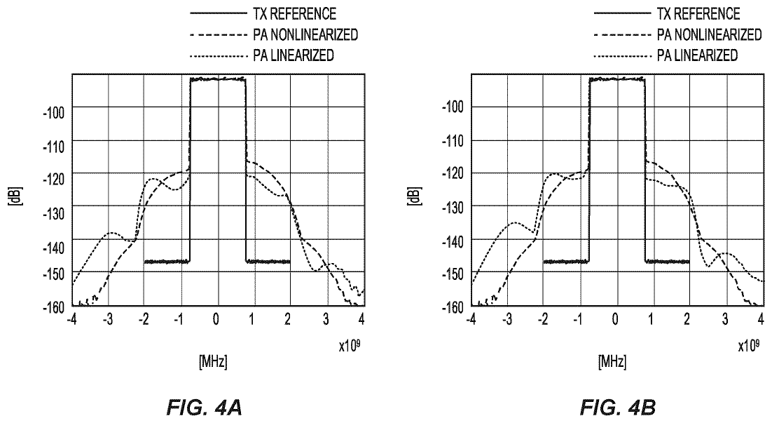

First, an identical pre-distorted input signal was applied to all three PAs, and the output power, EVM, and ALCR were estimated. As expected, the performance for the 50-ohm impedance case was the best, since that was the PA to which the DPD model was adapted. The result for the 25-ohm case was that the output power of the PA driving the 25-ohm impedance was 1.1 dB lower than for the one driving the 50-ohm impedance. Also, ACLR and EVM were degraded. Since a detector at the output would measure a lower output voltage than that of the 50-ohm reference PA, a gain controller could increase the gain of the input signal to the 25-ohm PA. To simulate this, a linear gain was added to increase the input signal so that the output power of the PA driving the 25-ohm load impedance was increased by 1.1 dB, and again the output power, EVM, and ACLR were estimated. Table 1 and FIGS. 4A and 4B summarize the results.

TABLE 1
Effect of Gain Modification on DPD-Linearized Performance

| | | | EVM | | |
|---|---|---|---|---|---|
| | Input signal | ACLR | [%] | Output | Output |
| PA- | Gain | [dBc] | 3GPP | Power | Impedance |
| model | Modification | low/high | equalizer | [dBm] | [ohm] |
| 50- | 0 dB | 37.1/36.0 | 1.1 | 13.3 | 50 |
| ohm | | | | | |
| 25- | 0 dB | 32.2/33.3 | 4.2 | 12.2 | 25 |
| ohm | +1.1 dB | 30.0/32.6 | 4.15 | 13.3 | 25 |
| 100- | 0 dB | 31.6/27.6 | 6.9 | 13.4 | 100 |
| ohm | −4.1 dB | 31.8/35.5 | 4.9 | 10.2 | 100 |

As Table 1 shows, for the 25-ohm load impedance case, increasing the gain of the programmable gain amplifier preceding the PA by 1.1 dB brought the output power up, to equal that of the 50-ohm impedance PA. ACLR and EVM both improved. FIG. 4A depicts the Tx reference, non-linearized, and linearized simulations without any gain modification. The Tx reference case is the input signal linearly amplified, without any distortion introduced by the PA. The non-linearized case is with PA distortion without the DPD, and the linearized case is with the DPD operating. FIG. 4B shows simulation result graphs of the same three signals, with the gain modification of +1.1 dB.

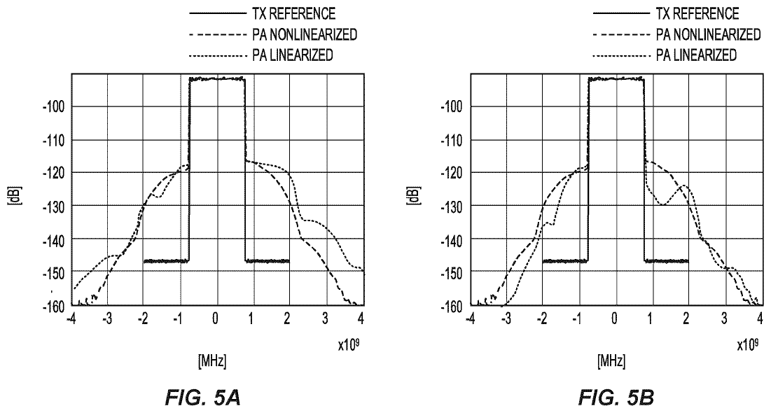

The 100-ohm load impedance PA model was then stimulated, with and without the same pre-distorted input signal that was adapted for the 50-ohm impedance model. As Table 1 shows, distortion increased significantly, and output power increased only slightly. In this case, the detector at the PA output could detect that the output voltage swing exceeded that of the 50-ohm reference case. This is a clear indicator that input signal should be reduced for this PA. Accordingly, a linear gain reduction of 4.1 dB was applied and the simulation run again, resulting in a reduction of the EVM, a slight increase in ACLR, and a significant reduction in the output power. FIG. 5A plots the Tx reference, non-linearized, and linearized simulation results with no gain modification, and FIG. 5B plots the same signals with a −4.1 dB gain reduction applied to the programmable gain amplifier.

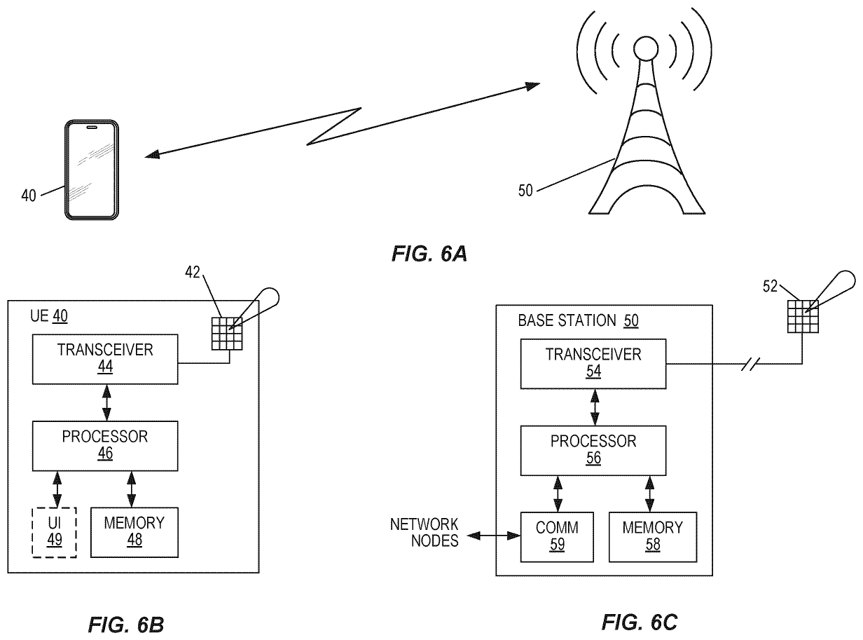

FIG. 6A is a diagram of wireless transmission over the air interface of a wireless communication network. A User Equipment (UE) 40, such as a smartphone, receives and transmits modulated Radio Frequency (RF) signals from and to a base station 50, such as an LTE eNB or an NR gNB. One or both of the UE 40 and base station 50 may implement beamforming at least in the transmitter, wherein the directionality of signal propagation from an antenna array is increased and controlled by controlling the phases of the signals to multiple antenna elements. As discussed above, this changes the load impedance seen at various of the antenna elements, leading to divergence in the output amplitude and distortion at the associated PAs 20. Accordingly, one of both of the UE 40 and base station 50 employ a transmitter 10 according to aspects of the present disclosure.

FIG. 6B is a block diagram of the UE 40 of FIG. 6A. As used herein, the term UE may refer to a user-operated telephony terminal, a machine-to-machine (M2M) device, a machine-type communications (MTC) device, a Narrowband Internet of Things (NB-IoT) device (in particular a UE implementing the 3GPP standard for NB-IoT), etc. A UE 40 may also be referred to as a radio device, a radio communication device, a wireless communication device, a wireless terminal, or simply a terminal-unless the context indicates otherwise, the use of any of these terms is intended to include device-to-device UEs or devices, machine-type devices or devices capable of machine-to-machine communication, sensors equipped with a radio network device, wireless-enabled table computers, mobile terminals, smartphones, laptop-embedded equipped (LEE), laptop-mounted equipment (LME), USB dongles, wireless customer-premises equipment (CPE), and the like.

The UE 40 transmits and receives RF signals (including beamformed signals) using at least one antenna array 42. The antenna array 42 may be an AAS, and may be part of a transmitter 10, according to aspects of the present disclosure. The RF signals are generated, and received, by one or more transceiver circuits 44. The transceiver circuits 44, as well as other components of the UE 40, are controlled by processing circuitry 46. Memory 48 operatively connected to the processing circuitry 46 stores software in the form of computer instructions operative to control the processing circuitry 46. A user interface 49 may include output devices such as a display and speakers (and/or a wired or wireless connection to audio devices such as ear buds), and/or input devices such as buttons, a keypad, a touchscreen, and the like. As indicated by the dashed lines, the user interface 49 may not be present in all UEs 40; for example, UEs 40 designed for Machine Type Communications (MTC) such as Internet of Things (IoT) devices, may perform dedicated functions such as sensing/measuring, monitoring, meter reading, and the like, and may not have any user interface 49 features.

FIG. 6C is a block diagram of the base station 50 of FIG. 6A. A base station 50—known in various network implementations as a Radio Base Station (RBS), Base Transceiver Station (BTS), Node B (NB), enhanced Node B (eNB), Next Generation Node B (gNB), or the like—is a node of a wireless communication network that implements a Radio Access Network (RAN) in a defined geographic area called a cell, by providing radio transceivers to communicate wirelessly with a plurality of UEs 40.

The base station 50 transmits and receives RF signals (including beamformed signals) on an antennas array 52. The antenna array 52 may be an AAS, and may be part of a transmitter 10, according to aspects of the present disclosure. As indicated by the broken line, the antenna array 52 may be located remotely from the base station 50, such as on a tower or building. The RF signals are generated, and received, by one or more transceiver circuits 54. The transceiver circuits 54, as well as other components of the base station 50, are controlled by processing circuitry 56. Memory 58 operatively connected to the processing circuitry 56 stores instructions operative to control the processing circuitry 56. Although the memory 58 is depicted as being separate from the processing circuitry 56, those of skill in the art understand that the processing circuitry 56 includes internal memory, such as a cache memory or register file. Those of skill in the art additionally understand that virtualization techniques allow some functions nominally executed by the processing circuitry 56 to actually be executed by other hardware, perhaps remotely located (e.g., in the so-called “cloud”). Communication circuitry 59 provides one or more communication links to one or more other network nodes, propagating communications to and from UEs 40, from and to other network nodes or other networks, such as telephony networks or the Internet.

In all embodiments, the processing circuitry 46, 56 may comprise any sequential state machine operative to execute machine instructions stored as machine-readable computer programs in memory 48, 58, such as one or more hardware-implemented state machines (e.g., in discrete logic, FPGA, ASIC, etc.); programmable logic together with appropriate firmware; one or more stored-program, general-purpose processors, such as a microprocessor or Digital Signal Processor (DSP), together with appropriate software; or any combination of the above.

In all embodiments, the memory 48, 58 may comprise any non-transitory machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

In all embodiments, the transceiver circuits 44, 54 are operative to communicate with one or more other transceivers via a Radio Access Network (RAN) according to one or more communication protocols known in the art or that may be developed, such as IEEE 802.xx, CDMA, WCDMA, GSM, LTE, UTRAN, WiMax, NB-IoT, or the like. The transceiver 34, 44 implements transmitter and receiver functionality appropriate to the RAN links (e.g., frequency allocations and the like). The transmitter and receiver functions may share circuit components and/or software, or alternatively may be implemented separately. In particular, the transceiver circuits 44, 54 employ a distributed LO signal generation scheme, in which a plurality of PLLs each generate LO signals as required for frequency conversion and the like. Alternatively, the transceiver circuits 44, 54 may employ direct RF conversion. To mitigate the deleterious effects of coupling of oscillators in the various PLLs, according to aspects of the present disclosure, pairwise phase difference regulation is performed on associated pairs of PLLs, as described herein.

In all embodiments, the communication circuitry 59 may comprise a receiver and transmitter interface used to communicate with one or more other nodes over a communication network according to one or more communication protocols known in the art or that may be developed, such as Ethernet, TCP/IP, SONET, ATM, IMS, SIP, or the like. The communication circuits 49 implement receiver and transmitter functionality appropriate to the communication network links (e.g., optical, electrical, and the like). The transmitter and receiver functions may share circuit components and/or software, or alternatively may be implemented separately.

Aspects of the present disclosure provide numerous advantages over the prior art. By equalizing the PA 20 outputs in transmitter paths 14 receiving communication signals from the same DAC 12, the distortion of the PAs 20, on average, is made more equal and thereby simpler for the DPD to suppress, resulting in a more linear transmission signal. Additionally, equalizing PA 20 output voltages increases the reachable output power, by increasing input signals to PAs 20 driving low impedance loads which result in a low output voltage, hence achieving a higher output power on average. Furthermore, excessive voltage stress is reduced for PAs 20 that drive high impedance loads, which gives rise to excessively high voltage swings, hence achieving reduced device stress and increased reliability, and thereby increased lifetime.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspect, and vice versa. Other objectives, features, and advantages of the enclosed aspects will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to.” As used herein, the term “substantially” means nearly or essentially, but not necessarily completely; the term encompasses and accounts for mechanical or component value tolerances, measurement error, random variation, and similar sources of imprecision. As used herein, the term RF stands for Radio Frequency, and includes frequencies in the range 20 kHz to 300 GHz. Accordingly, “RF” includes microwave and millimeter wave frequencies.

Some of the aspects contemplated herein are described more fully with reference to the accompanying drawings. Other aspects, however, are contained within the scope of the subject matter disclosed herein. The disclosed subject matter should not be construed as limited to only the aspects set forth herein; rather, these aspects are provided by way of example to convey the scope of the subject matter to those skilled in the art.

1-19. (canceled)

20. A transmitter for a wireless communication device, comprising:
a Digital to Analog Converter (DAC) configured to convert a digital communication signal to an analog communication signal;
a plurality of transmitter paths, each transmitter path configured to receive the analog communication signal and output a transmission signal, wherein each transmitter path comprises
a programmable gain amplifier configured to receive the analog communication signal and output an amplified analog communication signal;
a Power Amplifier (PA) configured to receive the amplified analog communication signal and output the transmission signal; and
a voltage detector connected to an output of the PA and configured to measure a voltage amplitude of the transmission signal; and
a controller connected to each voltage detector and each programmable gain amplifier, the controller configured to adjust a gain of each programmable gain amplifier so as to reduce variation in the voltage amplitudes of the plurality of transmission signals.

21. The transmitter of claim 20, wherein each transmitter path further comprises an antenna element electrically connected to the output of the PA.

22. The transmitter of claim 21, wherein each antenna element is electrically connected to the output of the PA via an antenna switch.

23. The transmitter of claim 20, wherein the controller is configured to adjust the gain of each programmable gain amplifier by calculating a median voltage amplitude; and
for each transmitter path comparing the measured voltage amplitude to the median voltage amplitude; and
adjusting the gain to drive the voltage amplitude towards the median voltage amplitude.

24. The transmitter of claim 23, wherein the controller is further configured to, prior to calculating the median voltage amplitude:
obtain a nominal gain value; and
for each transmitter path
set the gain to the nominal gain value; and
measure the voltage amplitude of the transmission signal.

25. The transmitter of claim 20, wherein the digital communication signal includes Digital PreDistortion, DPD.

26. The transmitter of claim 20, wherein the transmitter is part of an Antenna Array System (AAS) configured to implement beamforming at least partially in analog circuits.

27. The transmitter of claim 26, wherein the controller is configured to adjust the gain of each programmable gain amplifier at least upon the AAS steering a transmit beam to a different angle.

28. The transmitter of claim 20, wherein the controller is configured to adjust the gain of each programmable gain amplifier when the voltage amplitudes of a predetermined number of transmission signals have deviated a predetermined amount from the voltage amplitudes set during an immediately prior gain adjustment.

29. The transmitter of claim 20, wherein the controller is further configured to adjust the gain of each programmable gain amplifier so as to limit the voltage amplitudes of the plurality of transmission signals to not exceed a predetermined threshold.

30. The transmitter of claim 20, wherein the controller is further configured to adjust the gain of each programmable gain amplifier so as to limit currents of the plurality of transmission signals to not exceed a predetermined threshold.

31. The transmitter of claim 30, wherein the current threshold for each transmission signal is estimated from gain applied to the corresponding programmable gain amplifier.

32. The transmitter of claim 30, wherein each transmitter path further comprises a voltage detector connected to the input of the PA and to the controller, and wherein the current threshold for each transmission signal is estimated from a voltage amplitude of the amplified analog communication signal.

33. A method of equalizing Power Amplifier (PA) outputs in a transmitter comprising a Digital to Analog Converter (DAC) and a plurality of transmitter paths, each configured to receive the same analog signal from the DAC and each comprising a serial connection of a programmable gain amplifier, a PA, and a voltage detector, the method comprising:
for each transmitter path
setting a gain G_{PA} for the programmable gain amplifier equal to a nominal gain Gₙₒₘ; and
measuring a voltage amplitude Vₒᵤₜ at the output of the PA;
calculating a median PA output voltage amplitude V_{median} and for each transmitter path
repeat
comparing the measured voltage amplitude Vₒᵤₜ to the median PA output voltage amplitude V_{median};
if Vₒᵤₜ<V_{median} increasing the gain, if possible;
if Vₒᵤₜ>V_{median} decreasing the gain, if possible; and
measuring a new voltage amplitude Vₒᵤₜ at the output of the PA;
until either Vₒᵤₜ=V_{median} within a predetermined tolerance, or no further adjustment of the gain is possible.

34. The method of claim 33, further comprising, prior to performing the method, obtaining the nominal gain Gₙₒₘ for the programmable gain amplifiers.

35. The method of claim 33, further comprising repeating the method steps at least following a beamforming angle change in excess of a predetermined threshold.

36. The method of claim 33, further comprising repeating the method steps when the voltage amplitudes of a predetermined number of transmission signals have deviated a predetermined amount from the voltage amplitudes set during an immediately prior execution of the method.

37. User Equipment (UE) configured to operate in a wireless communication network, the UE including one or more transmitters comprising:
a Digital to Analog Converter (DAC) configured to convert a digital communication signal to an analog communication signal;
a plurality of transmitter paths, each transmitter path configured to receive the analog communication signal and output a transmission signal, wherein each transmitter path comprises
a programmable gain amplifier configured to receive the analog communication signal and output an amplified analog communication signal;
a Power Amplifier (PA) configured to receive the amplified analog communication signal and output the transmission signal; and
a voltage detector connected to an output of the PA and configured to measure a voltage amplitude of the transmission signal; and
a controller connected to each voltage detector and each programmable gain amplifier, the controller configured to adjust a gain of each programmable gain amplifier so as to minimize variation in the voltage amplitudes of the plurality of transmission signals.

38. A base station, operative in a wireless communication network, the base station including one or more transmitters comprising:
a Digital to Analog Converter (DAC) configured to convert a digital communication signal to an analog communication signal;
a plurality of transmitter paths, each transmitter path configured to receive the analog communication signal and output a transmission signal, wherein each transmitter path comprises
a programmable gain amplifier configured to receive the analog communication signal and output an amplified analog communication signal;
a Power Amplifier (PA) configured to receive the amplified analog communication signal and output the transmission signal; and
a voltage detector connected to an output of the PA and configured to measure a voltage amplitude of the transmission signal; and
a controller connected to each voltage detector and each programmable gain amplifier, the controller configured to adjust a gain of each programmable gain amplifier so as to minimize variation in the voltage amplitudes of the plurality of transmission signals.
